(19) United States
(12) Patent Application Publication
(10) Pub. No.: US 2026/0292922 A1
(43) Pub. Date: Sep. 24, 2026

(54) Artificial Intelligence-Based Discontinuous Transmission Detection

(71) Applicant: Dell Products L.P., Round Rock, TX (US)

(72) Inventors: Eran Goldstein, Montreal (CA); Evgeny Paltin, Montreal (CA); Mohammed Abdelsadek, Kanata (CA)

(21) Appl. No.: 19/085,938

(22) Filed: Mar. 20, 2025

(51) Int. Cl. H04W 76/28; H04B 7/06; H04L 27/26; H04W 24/02; H04W 72/21

(52) U.S. Cl. CPC H04W 76/28; H04B 7/0617; H04L 27/2607; H04W 24/02; H04W 72/21

(57) ABSTRACT

A system can receive a protocol data unit from a user equipment via broadband cellular communications channel. The system can, based on determining that a cyclical redundancy check has failed for the protocol data unit, determine a channel estimation for the protocol data unit, transform the channel estimation from a frequency domain to a time domain, to produce a time-domain channel estimation, determine a channel history for the broadband cellular communications channel, estimate a rate of change for the broadband cellular communications channel, and input the time-domain channel estimation, the channel history, and the rate of change into a trained artificial intelligence model to produce an output that indicates whether the protocol data unit is classified as a discontinuous transmission. The system can conduct broadband cellular communications via the broadband cellular communications channel based on the output that indicates whether the protocol data unit is classified as the discontinuous transmission.

### BACKGROUND

A base station can facilitate broadband cellular communications with user equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a protocol data unit from a user equipment via broadband cellular communications channel. The system can, based on determining that a cyclical redundancy check has failed for the protocol data unit, determine a channel estimation for the protocol data unit, transform the channel estimation from a frequency domain to a time domain, to produce a time-domain channel estimation, determine a channel history for the broadband cellular communications channel, estimate a rate of change for the broadband cellular communications channel, and input the time-domain channel estimation, the channel history, and the rate of change into a trained artificial intelligence model to produce an output that indicates whether the protocol data unit is classified as a discontinuous transmission. The system can conduct broadband cellular communications via the broadband cellular communications channel based on the output that indicates whether the protocol data unit is classified as the discontinuous transmission.

An example method can comprise, based on determining, by a system comprising at least one processor, that a cyclical redundancy check fails for a protocol data unit that is from a user equipment via broadband cellular communications channel, determining a channel estimation for the protocol data unit, determining a channel history for the broadband cellular communications channel, and estimating a rate of change for the broadband cellular communications channel. The method can further comprise inputting, by the system, a time-domain representation of the channel estimation, the channel history, and the rate of change into a trained artificial intelligence model to produce an output that indicates whether the protocol data unit is classified as a discontinuous transmission. The method can further comprise conducting, by the system, broadband cellular communications via the broadband cellular communications channel based on the output that indicates whether the protocol data unit is classified as the discontinuous transmission.

An example non-transitory computer-readable medium can comprise instructions that, in response to execution, cause a system comprising a processor to perform operations. These operations can comprise, based on determining that a cyclical redundancy check has failed for a protocol data unit that is from a user equipment via broadband cellular communications channel, determining a channel estimation for the protocol data unit, determining a channel history for the broadband cellular communications channel, and determining a rate of change applicable to the broadband cellular communications channel. These operations can further comprise inputting a time-domain representation of the channel estimation, the channel history, and the rate of change to a trained artificial intelligence model. These operations can further comprise, in response to the inputting, obtaining an output from the trained artificial intelligence model, wherein the output indicates whether the protocol data unit is classified as a discontinuous transmission, and wherein broadband cellular communications of the broadband cellular communications channel are conducted based on the output.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate artificial intelligence-based discontinuous transmission detection, in accordance with an embodiment of this disclosure;

FIG. 2 illustrates an example of a power delay profile (PDP) channel estimation in a time (or delay) domain with a peak, and that can facilitate artificial intelligence-based discontinuous transmission detection, in accordance with an embodiment of this disclosure;

FIG. 3 illustrates an example of an anomaly detection based on clustered data points, and that can facilitate artificial intelligence-based discontinuous transmission detection, in accordance with an embodiment of this disclosure;

FIG. 4 illustrates an example architecture for artificial intelligence (AI)/machine learning (ML)-based discontinuous transmission (DTX) detection, and that can facilitate artificial intelligence-based discontinuous transmission detection, in accordance with an embodiment of this disclosure;

FIG. 5 illustrates an example process flow that can facilitate artificial intelligence-based discontinuous transmission detection, in accordance with an embodiment of this disclosure;

FIG. 6 illustrates an example process flow for offline training, and that can facilitate artificial intelligence-based discontinuous transmission detection, in accordance with an embodiment of this disclosure;

FIG. 7 illustrates another example process flow that can facilitate artificial intelligence-based discontinuous transmission detection, in accordance with an embodiment of this disclosure;

FIG. 8 illustrates another example process flow that can facilitate artificial intelligence-based discontinuous transmission detection, in accordance with an embodiment of this disclosure;

FIG. 9 illustrates another example process flow that can facilitate artificial intelligence-based discontinuous transmission detection, in accordance with an embodiment of this disclosure; and

FIG. 10 illustrates an example block diagram of a computer operable to execute an embodiment of this disclosure.

### DETAILED DESCRIPTION

### Overview

The present examples generally relate to fifth generation (5G) new radio (NR) broadband cellular communications. It can be appreciated that the present techniques can be applied to different broadband cellular communications technologies.

In broadband cellular communications, discontinuous transmission (DTX) can comprise an issue that occurs when base station is expecting a transmission from the user equipment (UE), and it is not received for some reason. If layer 1 (L1) detects such no-reception/a DTX state then it informs layer 2 (L2), which can take some actions based on that (e.g., ignoring reported physical uplink shared channel (PUSCH) measurements, adjusting transmit power commands (TPC), etc.).

In a fifth generation (5G) new radio (NR) air interface, the PUSCH is the main uplink (UL) channel that is used to carry the transport UL-shared channel (UL-SCH) and potentially uplink control information (UCI). 5G protocols can be designed such that Layer 2 (L2, the data link layer in the Open Systems Interconnection (OSI) model) configures Layer 1 (L1, the physical layer) to expect a PUSCH packet data unit (PDU) on a certain uplink slot, and L1 receives and decodes that PUSCH PDU, and reports its payload bits along with some measurements (e.g., signal to interference-plus-noise ratio (SINR), received signal strength indicator (RSSI), timing advance (TA), etc.). In some cases, the user equipment (UE) does not transmit certain scheduled PUSCH PDUs (e.g., due to missing its scheduling downlink control information (DCI)). However, L1 (and L2) would still expect the configured PUSCH PDU on the scheduled slot. In such scenarios, L1 can report a PUSCH discontinuous transmission (DTX) to L2 indicating that PUSCH was not received. However, as a detection technique, this is associated with detection, missed detection, and false alarm probabilities.

Similarly other channels, such as physical uplink control channel (PUCCH), can suffer from DTX, and the present techniques can work for those, as well.

The accuracy of detecting PUSCH DTX can be important for L2, as there can be other procedures and actions which depend on that DTX report from L1. For example, PUSCH DTX can be used to track the DCIs received by the UE, and hence the received transmit power commands (TPCs). This can make L2 aware of the target transmit power by the UE given all its transmitted TPC commands. Therefore, any missed detection or false alarm can impact the performance of the UL transmissions of the UEs.

Prior approaches adopted to detect PUSCH DTX include:
Comparing the post-processing SINR of PUSCH with a predetermined threshold to decide whether it is a DTX state.
Comparing the peak of the channel estimation in the window with a predetermined threshold to decide whether it is a DTX state.

The main problem of the approaches above are the high false alarm (FA) and misdetection rates in low SINR scenarios. This can be the case for cell edge UEs, where the PDCCH reception by the UE can also suffer from low SINR and consequently BLER. The following are examples that can benefit from implementation of the present techniques:
A case where a drop of SINR—even if it is not below a threshold—is to be considered as a DTX. This can be seen in channel estimation (ch. est) history.
A DTX can be detected even when a peak is present above the threshold by comparing the location of the current peak to the historical location and concluding that a too large change happened too quickly.

The present techniques can be implemented to facilitate PUSCH DTX detection utilizing artificial intelligence/machine learning (AI/ML) such that the missed detection and false alarm probabilities are minimized and to address the inaccuracies of conventional methods.

An example series of steps to implement the present techniques is as follows:
1. If a cyclical redundancy check (CRC) is trusted, the following can run only for CRC failure cases.
2. Performing channel estimation, which can comprise least squares (LS) estimation by multiplication by the conjugate of the pilot signal, or a linear minimum mean square error (LMMSE) estimator, or other (which can be up to each transmitter/receiver (Tx/Rx) antenna pair or received beam).
3. Performing conversion to delay domain (usually by performing an inverse Fast Fourier Transform (iFFT)) of the ch. est (which can be up to each Tx/Rx antenna pair or received beam).
4. Establishing channel history: The evolving channel estimation history can be used to determine if the current PUSCH channel estimation is different enough to be considered an outliner and consequently a DTX. To construct the channel history, CRC successful PUSCH or sounding reference signal (SRS) signals can be used, potentially per each receive antenna/each beam formed antenna port. In different examples, varying numbers of how many previous occasions can be used as inputs and can depend on the coherence time of the channel.
   Note that generating the channel history can be part of an AI/ML module output (in addition to the input), or a classical algorithm of averaging, or weighted averaging. Note that for constructing the historical channel estimation timing advance (TA) and transmission power control (TPC) commands issued at the base station side, that update the UE signal generation and impact the channel estimation can be used.
5. Estimate rate of change of the channel. This can be performed by measuring the Doppler spread over short period of time, or the rate of decorrelation of the channel estimation based on SRS.
6. Provide the following inputs to the AI/ML algorithm:
   a. Current ch. est;
   b. Issued commands since the update of historical ch. est (such as TA and TPC);
   c. Historical channel estimation;
   d. Estimated rate of change;
   e. Time gap between current ch. est and last update of the ch. est history;
   f. UE used Tx Antenna and precoding per PDP;
   g. Dimensionality reduction: The approach can have a reduced complexity form where N peaks are chosen out of the ch. est per receive antenna or beam formed port and their delay, phase and/or amplitude are used as inputs instead of the whole PDP. In some examples, an average of power outside of the peaks (e.g., noise and interference) can be used in conjunction with a subset of the peaks;
      i. In addition, another approach of reduced dimensionality can occur by using a windowed version of the ch. est, taking into accounts only some delays and ignoring less probable ones.
      ii. Another example approach to dimensionality reduction can comprise coherent (or incoherent) integration of multiple receive antennas into a single PDP (Power Delay Profile). A PDP can comprise an absolute square of a time-domain channel estimation.
7. The output of the AI/ML can be a decision of whether or not the signal was a DTX.

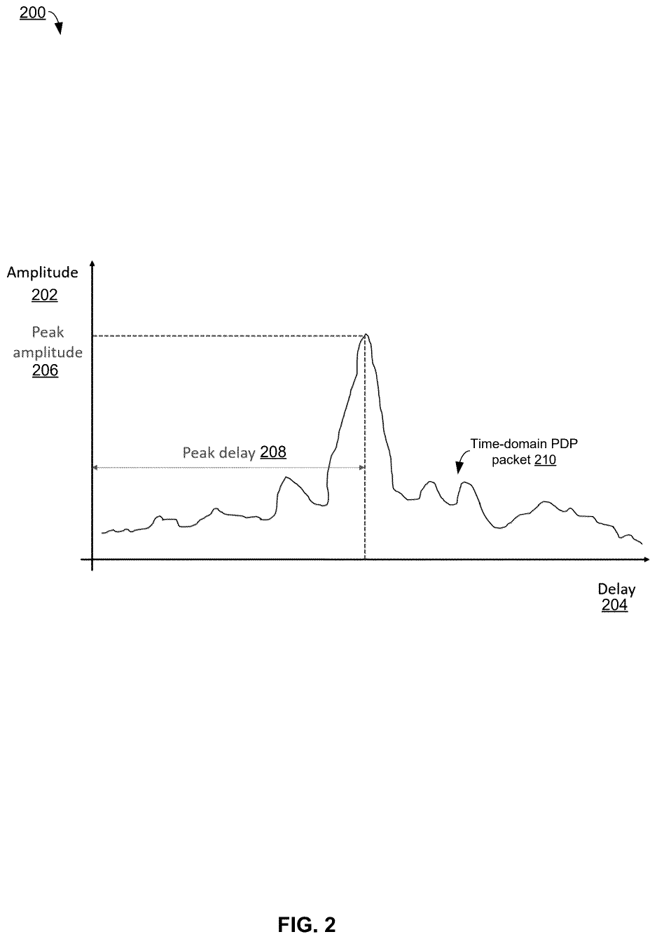

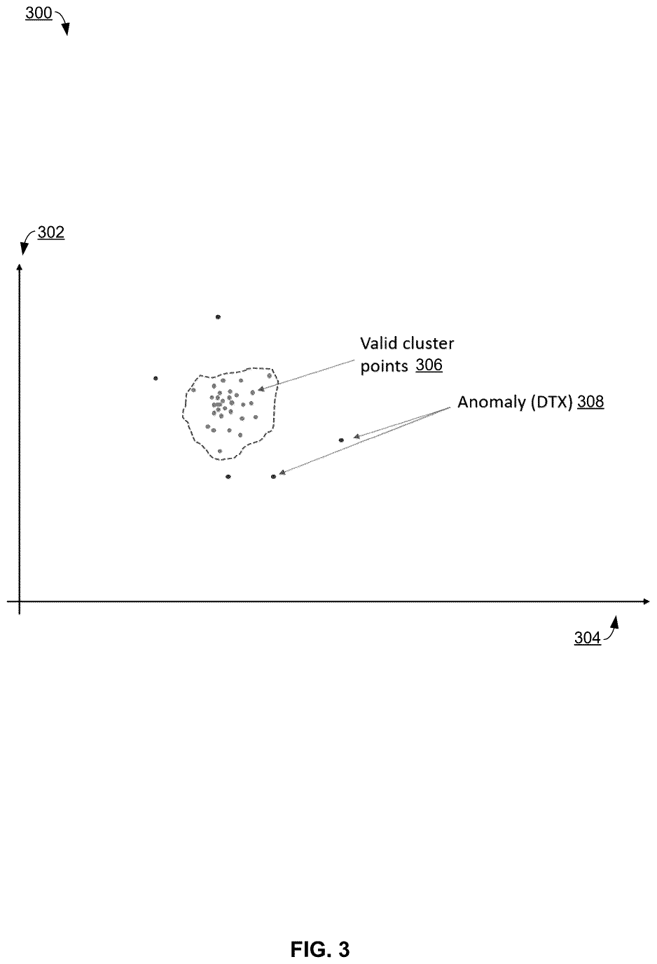

Offline learning of the AI/ML model can be performed according to the following example:
1. For each PUSCH PDU with sufficiently good SINR and a passing CRC:
   a. Determine the channel estimation in the delay domain in the considered window time. Note that this can already be calculated for other purposes, such as TA estimation.
   b. Determine the peak and its amplitude and delay (see FIG. 2). The whole delay domain samples can be used by trading off complexity with improved performance.
   c. Feed the parameters to the AI/ML model as a data point.
2. The unsupervised AI/ML model can use the provided data point as the main cluster points. Different AI/ML models can be used for this purpose such as:
   a. Isolation forest;
   b. Local outlier factor;
   c. Robust covariance;
   d. One-class support vector machine (SVM);
   e. One-class SVM with stochastic gradient descent (SGD); and
   f. Neural networks.
3. The AI/ML model can be used with the received PUSCH PDUs to determine if it is an anomaly based on its measured metrics (channel estimation in the delay domain) compared to that of the main cluster data points (see FIG. 3), which represent the PUSCH PDUs with good SINR and CRC pass.
4. The data for learning can be provided by the signals generated from an RLS and an L1 model.

### Example Architectures, Etc.

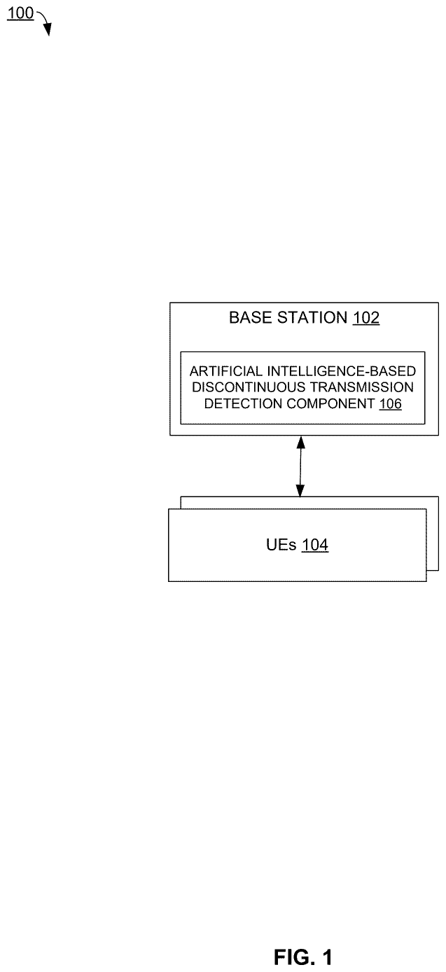

FIG. 1 illustrates an example system architecture 100 that can facilitate artificial intelligence-based discontinuous transmission detection, in accordance with an embodiment of this disclosure.

System architecture 100 comprises base station 102 and UEs 104. Base station 102 comprises artificial intelligence-based discontinuous transmission detection component 106.

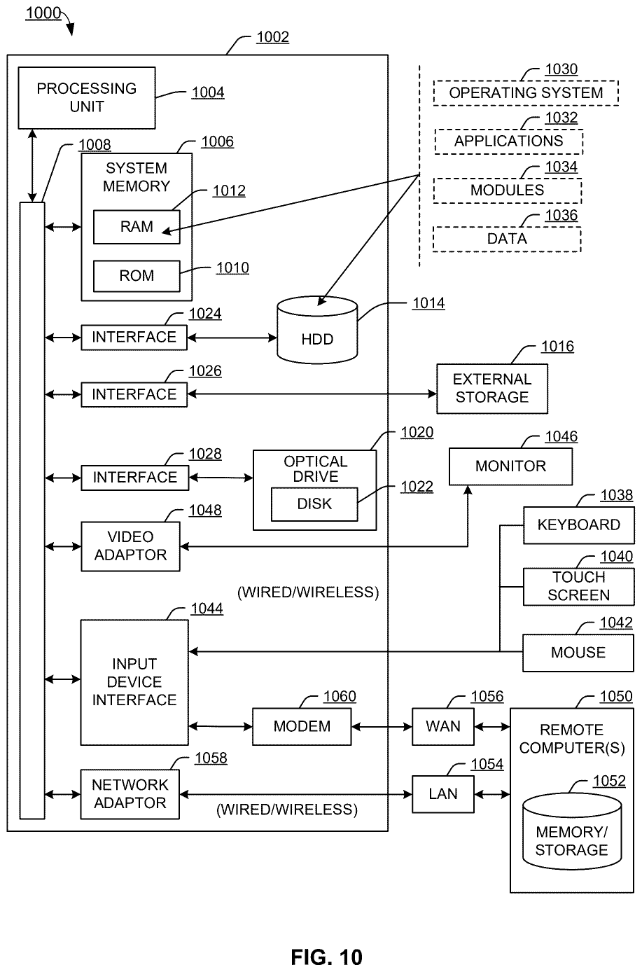

Each of base station 102 and/or UEs 104 can be implemented with part(s) of computing environment 1000 of FIG. 10.

Base station 102 can facilitate broadband cellular communications (e.g., 5G communications) with each UE of UEs 104. Artificial intelligence-based discontinuous transmission detection component 106 can use information about the status of cellular communications with one or more UEs of UEs 104 to determine whether there has been DTX.

This information can include items such as a current channel estimation, a historical channel estimation, an estimated rate of change, and a time gap between a current channel estimation, and a last update of the channel estimation history. This information can be input to an AI/ML model, which can use a clustering technique to classify PDP packets, and to classify outlier PDP packets as being DTX.

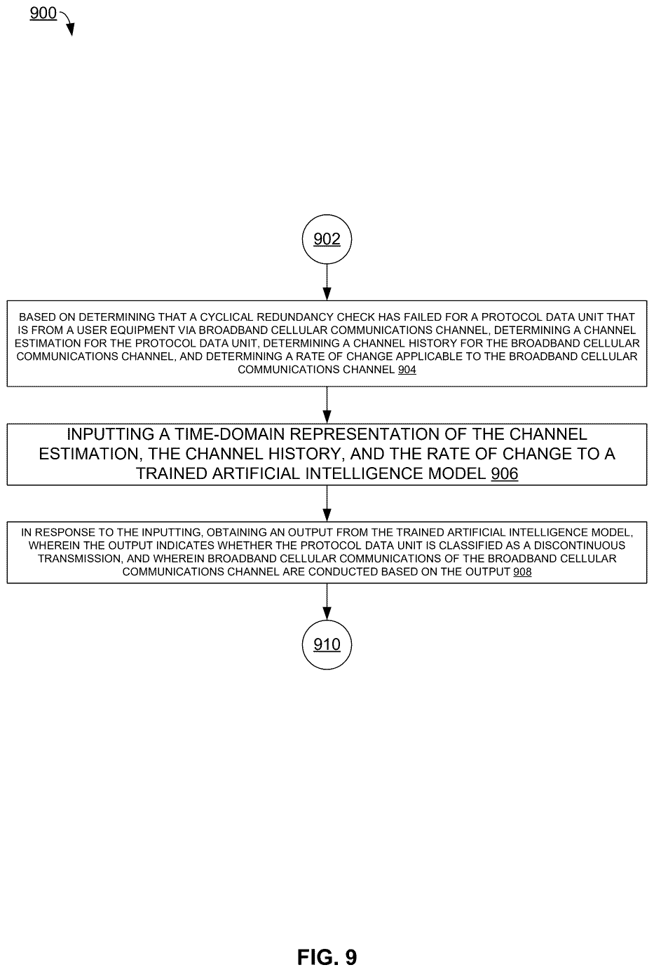

In some examples, artificial intelligence-based discontinuous transmission detection component 106 can implement part(s) of the process flows of FIGS. 9-11 to implement artificial intelligence-based discontinuous transmission detection.

It can be appreciated that system architecture 100 is one example system architecture for artificial intelligence-based discontinuous transmission detection, and that there can be other system architectures that facilitate artificial intelligence-based discontinuous transmission detection.

FIG. 2 illustrates an example 200 of a power delay profile (PDP) channel estimation in a time (or delay) domain with a peak, and that can facilitate artificial intelligence-based discontinuous transmission detection, in accordance with an embodiment of this disclosure. In some examples, part(s) of example 200 can be implemented by part(s) of system architecture 100 of FIG. 1 to facilitate artificial intelligence-based discontinuous transmission detection.

Example 200 comprises amplitude 202, delay 204, peak amplitude 206, peak delay 208, and time-domain PDP packet 210.

FIG. 3 illustrates an example 300 of an anomaly detection based on clustered data points, and that can facilitate artificial intelligence-based discontinuous transmission detection, in accordance with an embodiment of this disclosure. In some examples, part(s) of example 300 can be implemented by part(s) of system architecture 100 of FIG. 1 to facilitate artificial intelligence-based discontinuous transmission detection.

Example 300 comprises dimension 1 302, dimension 2 304 (where, in some examples, data points can be plotted and clustered according to N>2 dimensions), valid cluster points 306, and anomaly (DTX) 308.

That is, as data points of PDP packets are processed, they can be clustered according to features in a N-dimensional space. Where data points fall outside of a cluster, they can be determined to be DTX.

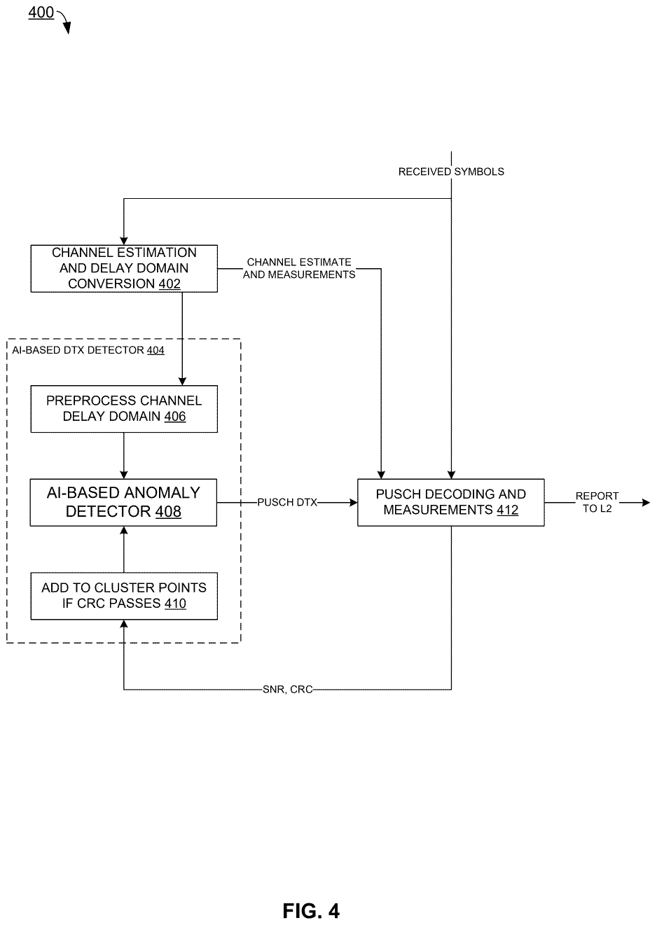

FIG. 4 illustrates an example system architecture 400 for artificial intelligence (AI)/machine learning (ML)-based discontinuous transmission (DTX) detection, and that can facilitate artificial intelligence-based discontinuous transmission detection, in accordance with an embodiment of this disclosure. In some examples, part(s) of system architecture 400 can be implemented by part(s) of system architecture 100 of FIG. 1 to facilitate artificial intelligence-based discontinuous transmission detection.

System architecture 400 comprises channel estimation and delay domain conversion 402, AI-based DTX detector 404, preprocess channel delay domain 406, AI-based anomaly detector 408, add to cluster points if CRC passes 410, and PUSCH decoding and measurements 412.

### Example Process Flows

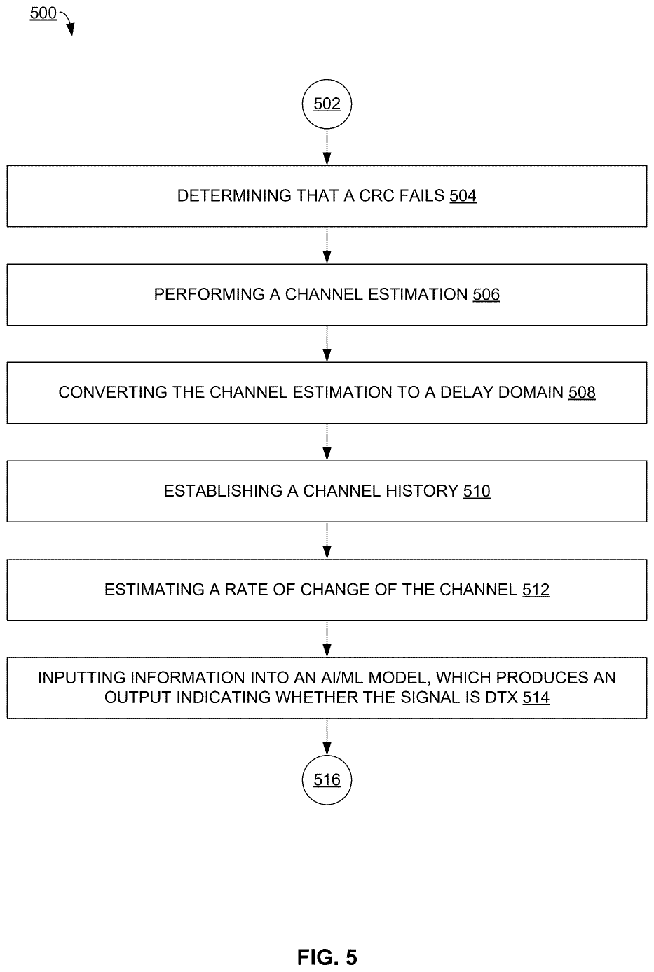

FIG. 5 illustrates an example process flow 500 that can facilitate artificial intelligence-based discontinuous transmission detection, in accordance with an embodiment of this disclosure. In some examples, one or more embodiments of process flow 500 can be implemented by artificial intelligence-based discontinuous transmission detection component 106 of FIG. 1, or computing environment 1000 of FIG. 10.

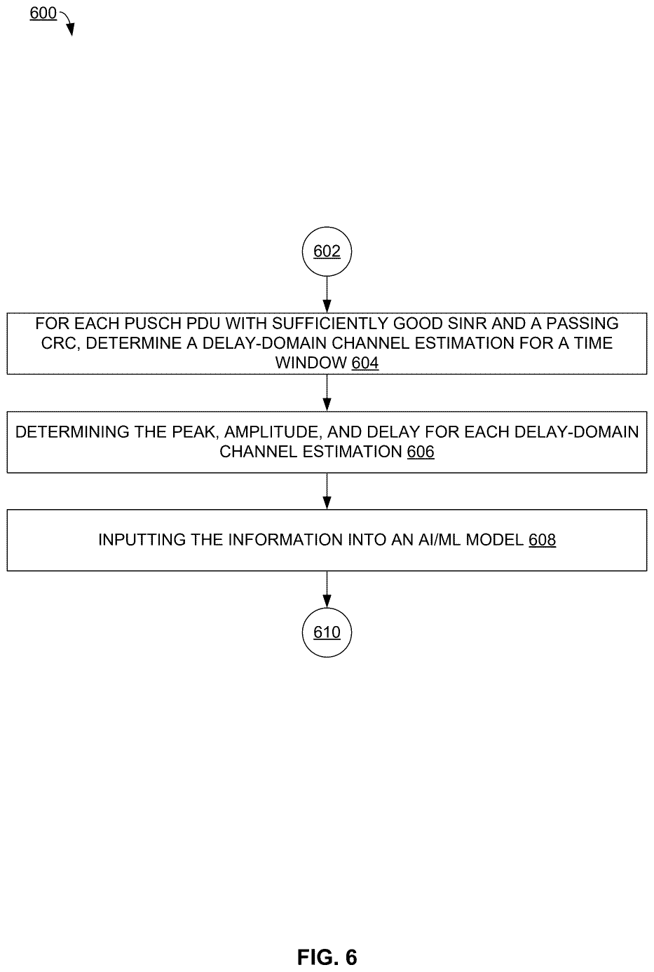

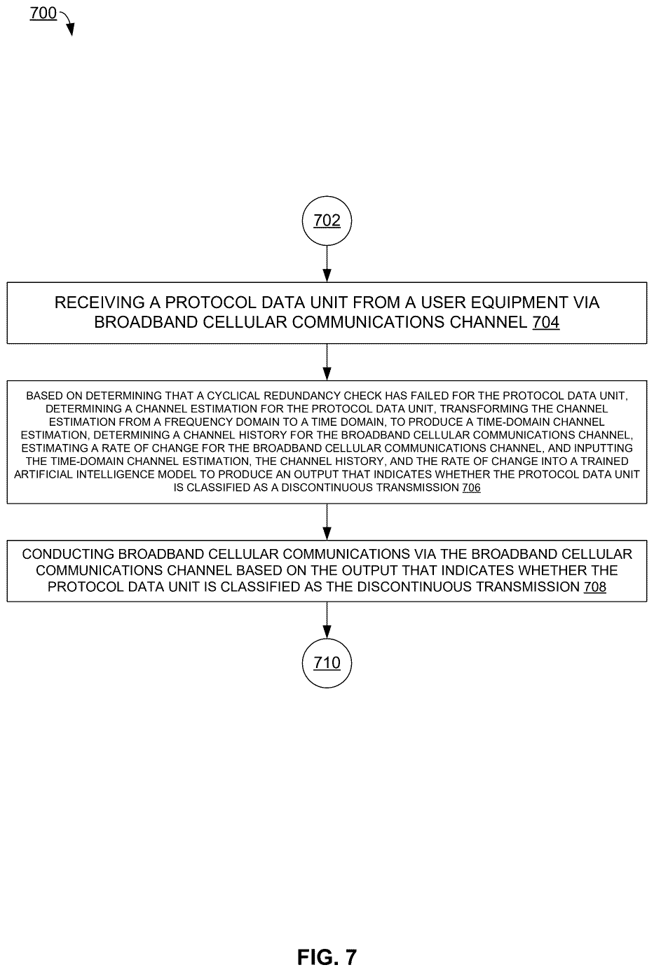

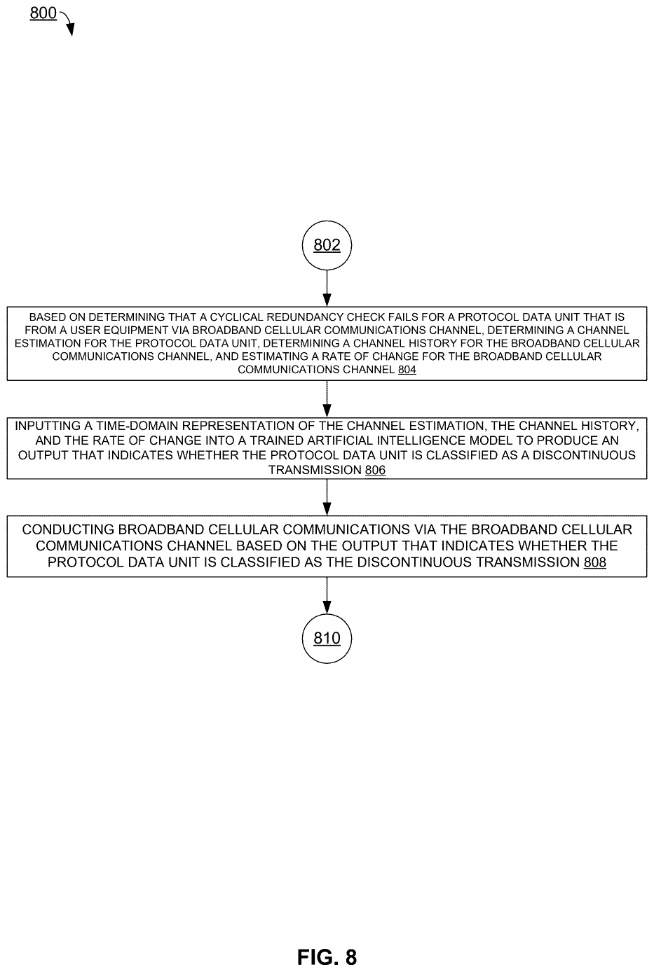

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts determining that a CRC fails for a PDP packet. Where a CRC passes, it can be determined that DTX did not occur, and further DTX analysis can be omitted.

After operation 504, process flow 500 moves to operation 506.

Operation 506 depicts performing a channel estimation for the PDP packet. This can comprise, for example, performing an LS estimation.

After operation 506, process flow 500 moves to operation 508.

Operation 508 depicts converting the channel estimation to a delay domain. This can comprise, for example, performing an iFFT on the channel estimation from operation 506.

After operation 508, process flow 500 moves to operation 510.

Operation 510 depicts establishing a channel history. This can comprise historical channel estimation data, and can be used to determine if the current PUSCH channel estimation is different enough to be considered an outliner and consequently a DTX. To construct the channel history, for example, CRC successful PUSCH or sounding reference signal (SRS) signals can be used, potentially per each receive antenna/each beam formed antenna port.

After operation 510, process flow 500 moves to operation 512.

Operation 512 depicts estimating a rate of change of the channel. In some examples, this can be performed by measuring the Doppler spread over short period of time, or the rate of decorrelation of the channel estimation based on SRS.

After operation 512, process flow 500 moves to operation 514.

Operation 514 depicts inputting information into an AI/ML model, which produces an output indicating whether the signal is DTX. The information can include the information from operations 506-512. There can be examples where more, or less, information is input into the AI/ML model.

After operation 514, process flow 500 moves to 516, where process flow 500 ends.

FIG. 6 illustrates an example process flow 600 that for offline training, and that can facilitate artificial intelligence-based discontinuous transmission detection, in accordance with an embodiment of this disclosure. In some examples, one or more embodiments of process flow 600 can be implemented by artificial intelligence-based discontinuous transmission detection component 106 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts, for each PUSCH PDU with sufficiently good SINR and a passing CRC, determine a delay-domain channel estimation for a time window. A sufficiently good SNR can be one that is at least a threshold SINR value.

After operation 604, process flow 600 moves to operation 606.

Operation 606 depicts determining the peak, amplitude, and delay for each delay-domain channel estimation. This can be similar to as depicted with respect to FIG. 2. In some examples, samples from the delay domain can be used, which can represent a tradeoff between complexity and performance.

After operation 606, process flow 600 moves to operation 608.

Operation 608 depicts inputting the information into an AI/ML model. These data points can be used for clustering, to train the model on what non-DTX looks like. Then, when new data points are input, those that are considered abnormal or outliers in terms of clustering can be considered to be DTX. In this manner, an AI/ML model can be trained to identify DTX data points via unsupervised learning.

After operation 608, process flow 600 moves to 610, where process flow 600 ends.

FIG. 7 illustrates another example process flow 700 that can facilitate artificial intelligence-based discontinuous transmission detection, in accordance with an embodiment of this disclosure. In some examples, one or more embodiments of process flow 700 can be implemented by artificial intelligence-based discontinuous transmission detection component 106 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts receiving a protocol data unit from a user equipment via broadband cellular communications channel. Using the example of FIG. 1, this can comprise base station 102 receiving a PDU from a UE of UEs 104.

After operation 704, process flow 700 moves to operation 706.

Operation 706 depicts, based on determining that a cyclical redundancy check has failed for the protocol data unit, determining a channel estimation for the protocol data unit, transforming the channel estimation from a frequency domain to a time domain, to produce a time-domain channel estimation, determining a channel history for the broadband cellular communications channel, estimating a rate of change for the broadband cellular communications channel, and inputting the time-domain channel estimation, the channel history, and the rate of change into a trained artificial intelligence model to produce an output that indicates whether the protocol data unit is classified as a discontinuous transmission. This can be performed in a similar manner as operations 506-514 of FIG. 5.

In some examples, the channel history is determined based on successful physical uplink shared channel signals, or wherein the channel history is determined based on successful sounding reference signal transmissions.

In some examples, the channel history is determined based on respective receive antennas of a group of receive antennas that facilitate the broadband cellular communications channel, or wherein the channel history is determined based on respective beam-formed antenna ports of a group of beam-formed antenna ports that facilitate the broadband cellular communications channel.

In some examples, the channel history is determined based on a number of received signals, and the number of received signals is based on a coherence time of the broadband cellular communications channel.

That is, a channel estimation history can be used to determine if the current PUSCH channel estimation is different enough to be considered an outliner and consequently a DTX. To construct the channel history, CRC successful PUSCH or sounding reference signal (SRS) signals can be used, potentially per each receive antenna/each beam formed antenna port.

In different examples, varying numbers of how many previous occasions can be used as inputs and can depend on the coherence time of the channel

After operation 706, process flow 700 moves to operation 708.

Operation 708 depicts conducting broadband cellular communications via the broadband cellular communications channel based on the output that indicates whether the protocol data unit is classified as the discontinuous transmission. Continuing with the example of FIG. 1, where DTX is detected, base station 102 can take one or more actions based on that, such as ignoring PUSCH measurements and/or adjusting TPCs.

In some examples, operation 708 depicts generating the trained artificial intelligence model, based on an unsupervised offline learning approach, comprising, for a group of physical uplink shared channel protocol data units, wherein respective physical uplink shared channel protocol data units of the physical uplink shared channel protocol data units correspond to a respective signal-to-noise and interference ratio that satisfies a quality criterion, and wherein the respective physical uplink shared channel protocol data units pass the cyclical redundancy check, determining respective channel estimations in the time domain for the respective physical uplink shared channel protocol data units for respective window times to generate respective first parameters, and determining respective peaks and corresponding respective amplitudes and respective delays for the respective physical uplink shared channel protocol data units, to produce respective second parameters, and inputting respective pairs comprising the respective first parameters and the respective second parameters as data points to an artificial intelligence model, to produce the trained artificial intelligence model, wherein the artificial intelligence model is configured to perform clustering on the data points, and wherein the trained artificial intelligence model is configured to determine whether the protocol data unit is classified as the discontinuous transmission based on the clustering. That is, offline learning of the model can be performed.

In some examples, the trained artificial intelligence model comprises an isolation forest model, a local outlier factor model, a robust covariance model, a one-class support vector machine model, or a one-class support vector machine with stochastic gradient descent model.

In some examples, operation 708 comprises generating the group of physical uplink shared channel protocol data units from a radio link simulation and a layer 1 model of cellular broadband communications.

After operation 708, process flow 700 moves to 710, where process flow 700 ends.

FIG. 8 illustrates another example process flow 800 that can facilitate artificial intelligence-based discontinuous transmission detection, in accordance with an embodiment of this disclosure. In some examples, one or more embodiments of process flow 800 can be implemented by artificial intelligence-based discontinuous transmission detection component 106 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts, based on determining that a cyclical redundancy check fails for a protocol data unit that is from a user equipment via broadband cellular communications channel, determining a channel estimation for the protocol data unit, determining a channel history for the broadband cellular communications channel, and estimating a rate of change for the broadband cellular communications channel. In some examples, operation 804 can be implemented in a similar manner as operations 704-706 of FIG. 7.

After operation 804, process flow 800 moves to operation 806.

Operation 806 depicts inputting a time-domain representation of the channel estimation, the channel history, and the rate of change into a trained artificial intelligence model to produce an output that indicates whether the protocol data unit is classified as a discontinuous transmission. In some examples, operation 806 can be implemented in a similar manner as operation 706 of FIG. 7.

In some examples, the output of the trained artificial intelligence model comprises an updated channel history that comprises an update to the channel history.

In some examples, the channel history comprises an average of respective signals of received signals.

In some examples, determining the channel history comprises determining the channel history based on a group of transmit power control commands issued to the user equipment, or wherein determining the channel history comprises determining the channel history based on a group of timing advance commands issued to the user equipment.

That is, in some examples, generating the channel history can be part of an AI/ML module output (in addition to the input), or a classical algorithm of averaging, or weighted averaging.

Note that for constructing the historical channel estimation timing advance (TA) and transmission power control (TPC) commands issued at the base station side, that update the UE signal generation and impact the channel estimation can be used.

In some examples, estimating the rate of change for the broadband cellular communications channel comprises estimating the rate of change based on a Doppler spread of the broadband cellular communications channel over a specified time period, or wherein estimating the rate of change for the broadband cellular communications channel comprises estimating the rate of change based on a rate of decorrelation of the channel estimation, the rate of decorrelation having been determined based on sounding reference signal transmissions.

In some examples, the inputting further comprises inputting an indication of a command issued to the user equipment to the trained artificial intelligence model, wherein the command was issued subsequent to a most-recent update of the channel history, and wherein the command comprises a transmit power control command or a timing advance command.

In some examples, the inputting further comprises inputting an indication of an amount of time that has elapsed between a first time of the channel estimation and a second time a most-recent update to the channel history to the trained artificial intelligence model.

After operation 806, process flow 800 moves to operation 808.

Operation 808 depicts conducting broadband cellular communications via the broadband cellular communications channel based on the output that indicates whether the protocol data unit is classified as the discontinuous transmission. In some examples, operation 808 can be implemented in a similar manner as operation 708 of FIG. 7.

After operation 808, process flow 800 moves to 810, where process flow 800 ends.

FIG. 9 illustrates another example process flow 900 that can facilitate artificial intelligence-based discontinuous transmission detection, in accordance with an embodiment of this disclosure. In some examples, one or more embodiments of process flow 900 can be implemented by artificial intelligence-based discontinuous transmission detection component 106 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts, based on determining that a cyclical redundancy check has failed for a protocol data unit that is from a user equipment via broadband cellular communications channel, determining a channel estimation for the protocol data unit, determining a channel history for the broadband cellular communications channel, and determining a rate of change applicable to the broadband cellular communications channel. In some examples, operation 904 can be implemented in a similar manner as operations 704-706 of FIG. 7.

After operation 904, process flow 900 moves to operation 906.

Operation 906 depicts inputting a time-domain representation of the channel estimation, the channel history, and the rate of change to a trained artificial intelligence model. In some examples, operation 906 can be implemented in a similar manner as operation 706 of FIG. 7.

In some examples, the inputting further comprises inputting, to the trained artificial intelligence model, an indication of a transmit antenna and precoding per power delay profile that was used by the user equipment.

In some examples, operation 906 comprises reducing a dimensionality of the time-domain channel estimation to produce a reduced-dimension channel estimation, wherein inputting the time-domain channel estimation to the trained artificial intelligence model comprises inputting the reduced-dimension channel estimation to the trained artificial intelligence model.

In some examples, the reducing of the dimensionality of the time-domain channel estimation comprises selecting a subset of peaks of a group of peaks of the time-domain channel estimation.

In some examples, the reducing of the dimensionality of the time-domain channel estimation comprises utilizing a delay of the time-domain channel estimation, a phase of the time-domain channel estimation, or an amplitude of the time-domain channel estimation as the reduced-dimension channel estimation.

In some examples, the reducing of the dimensionality of the time-domain channel estimation comprises creating a time-windowed-version of the time-domain channel estimation, wherein the time-windowed-version of the time-domain channel estimation comprises a first time that corresponds to a first channel estimation that satisfies a probability criterion, and wherein the time-windowed-version of the time-domain channel estimation omits a second time that corresponds to a second channel estimation that fails to satisfy the probability criterion.

That is, the present techniques can have a reduced complexity form where N peaks are chosen out of the ch. est per receive antenna or beam formed port and their delay, phase and/or amplitude are used as inputs instead of the whole PDP. In addition, another approach of reduced dimensionality can occur by using a windowed version of the ch. est, taking into accounts only some delays and ignoring less probable ones.

Another example approach to dimensionality reduction can comprise coherent (or incoherent) integration of multiple receive antennas into a single PDP (Power Delay Profile). A PDP can comprise an absolute square of a time-domain channel estimation.

After operation 906, process flow 900 moves to operation 908.

Operation 908 depicts, in response to the inputting, obtaining an output from the trained artificial intelligence model, wherein the output indicates whether the protocol data unit is classified as a discontinuous transmission, and wherein broadband cellular communications of the broadband cellular communications channel are conducted based on the output. In some examples, operation 908 can be implemented in a similar manner as operation 708 of FIG. 7.

After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of base station 102, and/or UEs 104.

In some examples, computing environment 1000 can implement one or more embodiments of the process flows of FIGS. 9-11 to facilitate artificial intelligence-based discontinuous transmission detection.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a protocol data unit from a user equipment via broadband cellular communications channel;
based on determining that a cyclical redundancy check has failed for the protocol data unit,
determining a channel estimation for the protocol data unit,
transforming the channel estimation from a frequency domain to a time domain, to produce a time-domain channel estimation,
determining a channel history for the broadband cellular communications channel,
estimating a rate of change for the broadband cellular communications channel, and
inputting the time-domain channel estimation, the channel history, and the rate of change into a trained artificial intelligence model to produce an output that indicates whether the protocol data unit is classified as a discontinuous transmission; and
conducting broadband cellular communications via the broadband cellular communications channel based on the output that indicates whether the protocol data unit is classified as the discontinuous transmission.

2. The system of claim 1, wherein the operations further comprise:
generating the trained artificial intelligence model, based on an unsupervised offline learning approach, comprising:
for a group of physical uplink shared channel protocol data units, wherein respective physical uplink shared channel protocol data units of the physical uplink shared channel protocol data units correspond to a respective signal-to-noise and interference ratio that satisfies a quality criterion, and wherein the respective physical uplink shared channel protocol data units pass the cyclical redundancy check,
determining respective channel estimations in the time domain for the respective physical uplink shared channel protocol data units for respective window times to generate respective first parameters, and
determining respective peaks and corresponding respective amplitudes and respective delays for the respective physical uplink shared channel protocol data units, to produce respective second parameters, and
inputting respective pairs comprising the respective first parameters and the respective second parameters as data points to an artificial intelligence model, to produce the trained artificial intelligence model, wherein the artificial intelligence model is configured to perform clustering on the data points, and wherein the trained artificial intelligence model is configured to determine whether the protocol data unit is classified as the discontinuous transmission based on the clustering.

3. The system of claim 2, wherein the trained artificial intelligence model comprises an isolation forest model, a local outlier factor model, a robust covariance model, a one-class support vector machine model, or a one-class support vector machine with stochastic gradient descent model.

4. The system of claim 2, wherein the operations further comprise:
generating the group of physical uplink shared channel protocol data units from a radio link simulation and a layer 1 model of cellular broadband communications.

5. The system of claim 1, wherein the channel history is determined based on successful physical uplink shared channel signals, or wherein the channel history is determined based on successful sounding reference signal transmissions.

6. The system of claim 1, wherein the channel history is determined based on respective receive antennas of a group of receive antennas that facilitate the broadband cellular communications channel, or wherein the channel history is determined based on respective beam-formed antenna ports of a group of beam-formed antenna ports that facilitate the broadband cellular communications channel.

7. The system of claim 1, wherein the channel history is determined based on a number of received signals, and the number of received signals is based on a coherence time of the broadband cellular communications channel.

8. A method, comprising:
based on determining, by a system comprising at least one processor, that a cyclical redundancy check fails for a protocol data unit that is from a user equipment via broadband cellular communications channel,
determining a channel estimation for the protocol data unit,
determining a channel history for the broadband cellular communications channel, and
estimating a rate of change for the broadband cellular communications channel;
inputting, by the system, a time-domain representation of the channel estimation, the channel history, and the rate of change into a trained artificial intelligence model to produce an output that indicates whether the protocol data unit is classified as a discontinuous transmission; and
conducting, by the system, broadband cellular communications via the broadband cellular communications channel based on the output that indicates whether the protocol data unit is classified as the discontinuous transmission.

9. The method of claim 8, wherein the output of the trained artificial intelligence model comprises an updated channel history that comprises an update to the channel history.

10. The method of claim 8, wherein the channel history comprises an average of respective signals of received signals.

11. The method of claim 8, wherein determining the channel history comprises determining the channel history based on a group of transmit power control commands issued to the user equipment, or wherein determining the channel history comprises determining the channel history based on a group of timing advance commands issued to the user equipment.

12. The method of claim 8, wherein estimating the rate of change for the broadband cellular communications channel comprises estimating the rate of change based on a Doppler spread of the broadband cellular communications channel over a specified time period, or wherein estimating the rate of change for the broadband cellular communications channel comprises estimating the rate of change based on a rate of decorrelation of the channel estimation, the rate of decorrelation having been determined based on sounding reference signal transmissions.

13. The method of claim 8, wherein the inputting further comprises:
inputting an indication of a command issued to the user equipment to the trained artificial intelligence model, wherein the command was issued subsequent to a most-recent update of the channel history, and wherein the command comprises a transmit power control command or a timing advance command.

14. The method of claim 8, wherein the inputting further comprises:
inputting an indication of an amount of time that has elapsed between a first time of the channel estimation and a second time a most-recent update to the channel history to the trained artificial intelligence model.

15. A non-transitory computer-readable medium comprising instructions that, in response to execution, cause a system comprising at least one processor to perform operations, comprising:
based on determining that a cyclical redundancy check has failed for a protocol data unit that is from a user equipment via broadband cellular communications channel,
determining a channel estimation for the protocol data unit,
determining a channel history for the broadband cellular communications channel, and
determining a rate of change applicable to the broadband cellular communications channel;
inputting a time-domain representation of the channel estimation, the channel history, and the rate of change to a trained artificial intelligence model; and
in response to the inputting, obtaining an output from the trained artificial intelligence model, wherein the output indicates whether the protocol data unit is classified as a discontinuous transmission, and wherein broadband cellular communications of the broadband cellular communications channel are conducted based on the output.

16. The system of claim 15, wherein the inputting further comprises:
inputting, to the trained artificial intelligence model, an indication of a transmit antenna and precoding per power delay profile that was used by the user equipment.

17. The system of claim 15, wherein the operations further comprise:
reducing a dimensionality of the time-domain channel estimation to produce a reduced-dimension channel estimation, wherein inputting the time-domain channel estimation to the trained artificial intelligence model comprises inputting the reduced-dimension channel estimation to the trained artificial intelligence model.

18. The system of claim 17, wherein the reducing of the dimensionality of the time-domain channel estimation comprises:
selecting a subset of peaks of a group of peaks of the time-domain channel estimation.

19. The system of claim 17, wherein the reducing of the dimensionality of the time-domain channel estimation comprises:
utilizing a delay of the time-domain channel estimation, a phase of the time-domain channel estimation, or an amplitude of the time-domain channel estimation as the reduced-dimension channel estimation.

20. The system of claim 17, wherein the reducing of the dimensionality of the time-domain channel estimation comprises:
creating a time-windowed-version of the time-domain channel estimation, wherein the time-windowed-version of the time-domain channel estimation comprises a first time that corresponds to a first channel estimation that satisfies a probability criterion, and wherein the time-windowed-version of the time-domain channel estimation omits a second time that corresponds to a second channel estimation that fails to satisfy the probability criterion.
